(19) United States
(12) Patent Application Publication
(10) Pub. No.: US 2016/0196478 A1
(43) Pub. Date: Jul. 7, 2016

(54) IMAGE PROCESSING METHOD AND DEVICE

(71) Applicant: SAMSUNG ELECTRONICS CO., LTD., Gyeonggi-do (KR)

(72) Inventors: Woong-il CHOI, Osan-si (KR); Dae-hee KIM, Suwon-si (KR)

(73) Assignee: SAMSUNG ELECTRONICS CO., LTD., Suwon-si (KR)

(21) Appl. No.: 14/916,392

(22) PCT Filed: Sep. 3, 2014
(86) PCT No.: PCT/KR2014/008284

§ 371 Date: Mar. 3, 2016

Related U.S. Application Data
(60) Provisional application No. 61/872,891, filed on Sep. 3, 2013.

(51) Int. Cl. G06K 9/62; G06F 17/30

(52) U.S. Cl. CPC G06K 9/6215; G06K 9/6202; G06F 17/30268; G06F 17/3033

(57) ABSTRACT

A similar image detection method can comprise the steps of: adjusting a similarity level to be used to determine the similarity between a plurality of images, on the basis of metadata of each of the plurality of images, wherein the metadata includes time information and/or location information of each of the plurality of images; and determining the similarity on the basis of a hash, which is generated using fingerprint information of each of the plurality of images, and the adjusted similarity level.

### TECHNICAL FIELD

The inventive concept relates to a method and apparatus for image processing, and more particularly, to a method and apparatus for detecting similar images from among a plurality of images.

### BACKGROUND ART

Pictures or videos that are similar to or the same as a given picture or video may be detected by analyzing a plurality of images and utilizing features of each of the images. Similar pictures and videos may be detected by performing image analysis, for example, feature extraction or image matching.

When similar pictures and videos are detected by only performing feature extraction or image matching, a non-similar image may be determined as a similar image.

Therefore, it is required to provide an image processing method and apparatus to detect images with high similarity from among a plurality of images.

### DETAILED DESCRIPTION OF THE INVENTION

### Technical Problem

According to an exemplary embodiment, a similar image detection method includes adjusting, based on metadata of each of a plurality of images, a similarity level used to determine a similarity between the plurality of images, wherein the metadata of each of the images includes at least one of time information and location information of each of the images; and determining the similarity based on the adjusted similarity level and a hash generated based on fingerprint information of each of the images.

### Advantageous Effects of the Invention

Provided are an image processing method and apparatus for accurately detecting images with high similarity from among a plurality of images.

Also, provided is a non-transitory computer-readable recording medium having recorded thereon a program, which, when executed by a computer, performs the method above. The technical goals of the present invention are not limited to the above and other technical goals may be derived from the exemplary embodiments shown below.

### BEST MODE

One or more exemplary embodiments provide a method of detecting similar images, the method comprising: adjusting, based on metadata of each of a plurality of images, a similarity level used to determine a similarity between the plurality of images, wherein the metadata of each of the images comprises at least one of time information and location information of each of the images; and determining the similarity based on the adjusted similarity level and a hash generated based on fingerprint information of each of the images.

wherein the adjusting of the similarity level comprises: comparing first metadata of a first image with second metadata of a second image from among the plurality of images; and adjusting, based on a result of the comparing, a similarity level used to determine a similarity between the first image and the second image.

wherein the adjusting of the similarity level used to determine the similarity between the first image and the second image comprises adjusting the similarity level according to a criterion that is predetermined based on a difference value of a value of the first metadata and a value of the second metadata.

wherein the criterion comprises a matching ratio of respective hash values of the first and second images, the matching ratio being set according to the difference value.

wherein the determining of the similarity comprises: matching respective hash values of the images to each other; and determining the similarity between the images based on a result of the matching and the adjusted similarity level.

The method further comprises extracting the metadata of each of the images. wherein the time information comprises at least one of a captured date, a captured time, and an edited time of each of the images, and the location information comprises GPS data of each of the images.

The method further comprises generating a hash based on fingerprint information of each of the images, wherein the fingerprint information comprises at least one of color difference signal distribution information, feature information, and edge detection information of each of the images.

wherein the color difference signal distribution information comprises at least one of a histogram of each of the images and a bit string of the histogram.

wherein the feature information is detected based on Speeded Up Robust Features (SURF) or Scale Invariant Feature Transform (SIFT), and the edge detection information is detected based on at least one of the discrete cosine transform (DCT), the Fourier-Mellin transform (FMT), and the Radon transform.

The method further comprises grouping similar images from among the plurality of images based on the determined similarity.

The method further comprises deleting from among a first image and a second image having an identical similarity the second image based on the determined similarity.

One or more exemplary embodiments provide an apparatus for detecting similar images, the apparatus comprising: a similarity level adjusting unit configured to adjust, based on metadata of each of a plurality of images, a similarity level used to determine a similarity between the plurality of images, wherein the metadata of each of the images comprises at least one of time information and location information of each of the images; and a similarity determining unit configured to determine the similarity based on the adjusted similarity level and a hash generated based on fingerprint information of each of the images.

wherein the similarity level adjusting unit is configured to compare first metadata of a first image and second metadata of a second image from among the plurality of images, and adjust, based on a result of the comparing, a similarity level used to determine a similarity between the first and second images.

One or more exemplary embodiments provide a non-transitory computer-readable recording medium having recorded thereon a program, which, when executed by a computer, performs a similar image detection method comprising: adjusting, based on metadata of each of a plurality of images, a similarity level used to determine a similarity between the plurality of images, wherein the metadata of each of the images comprises at least one of time information and location information of each of the images; and determining the similarity based on the adjusted similarity level and a hash generated based on fingerprint information of each of the images

### DESCRIPTION OF THE DRAWINGS

FIG. 1 is a conceptual diagram of detecting a similar image, according to an exemplary embodiment.

FIG. 2 is a block diagram of a similar image detection apparatus according to an exemplary embodiment.

FIG. 3 is a block diagram of a similar image detection apparatus according to another exemplary embodiment.

FIG. 4 is an exemplary diagram of a result of similar image detection, according to an exemplary embodiment.

FIG. 5 is an exemplary diagram of a result of similar image detection, according to another exemplary embodiment.

FIG. 6 is an exemplary diagram of a result of similar image detection, according to another exemplary embodiment.

FIG. 7 is diagrams for describing obtaining of fingerprint information of images by using histograms, according to an exemplary embodiment.

FIG. 8 is diagrams for describing obtaining fingerprint information of an image by feature extraction, according to another exemplary embodiment.

FIG. 9 is a flowchart of a method of detecting similar images, according to an exemplary embodiment.

FIG. 10 is a flowchart of a method of detecting similar images, according to another exemplary embodiment.

### MODE OF THE INVENTION

Hereinafter, some exemplary embodiments will be described with reference to accompanying drawings. However, the inventive concept is not limited to the exemplary embodiments. Like reference numerals in the drawings refer to like elements.

The terms used in the exemplary embodiments are selected as general terms used currently as widely as possible considering the functions in the present invention, but they may depend on the intentions of one of ordinary skill in the art, practice, the appearance of new technologies, etc.

In specific cases, terms arbitrarily selected by the applicant are also used, and in such cases, their meaning will be described in detail. Thus, it should be noted that the terms used in the specification should be understood not based on their literal names but by their given definitions and descriptions through the specification.

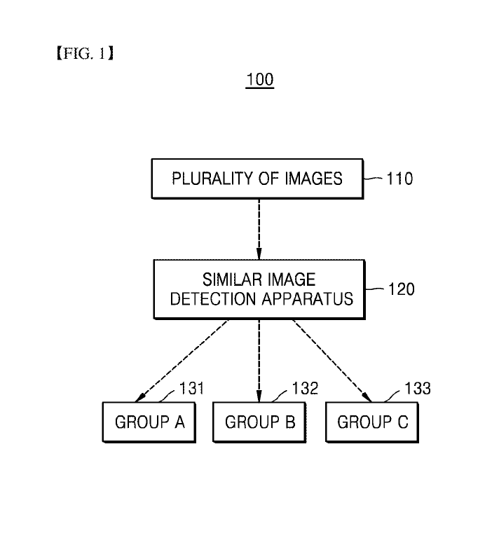

FIG. 1 is a conceptual diagram of detecting a similar image, according to an exemplary embodiment.

According to an exemplary embodiment, an apparatus 120 for detecting similar images may receive a plurality of images 110. The apparatus 120 may analyze the received plurality of images 110 and detect similar images 131, 132, and 133 from the plurality of images 110. An image may include a picture or a video.

According to an exemplary embodiment, ‘similar pictures’ may refer to pictures that may be recognized as being similar to each other by a user, for example, sequentially captured pictures or pictures of a person (or an item) at various angles. Conditions for determining the similar pictures (or similar videos) may be set by the user.

A picture or a video that is similar to or the same as a given picture or video may be detected by using metadata or by performing image analysis and using features of a plurality of images. The method of using metadata of the picture or the video may include identifying a file size, a captured time, etc. of data and determining whether pieces of data are identical. When the method of using metadata is used, detection may fail even when a slight change occurs in an image. Therefore, a similar image detecting apparatus may detect similar pictures and videos by performing image analysis, for example, feature extraction or image matching.

According to an exemplary embodiment, the apparatus 120 may extract fingerprints, which are unique features of the plurality of images, store the fingerprints in a hash format, compare hashes, and thus, determine a similarity of images. When fingerprint information indicates a plurality of similar images, values corresponding to the fingerprint information are similarly defined, and thus, the apparatus 120 may determine the similarity by comparing hash values thereof.

The apparatus 120 may include a digital device, for example, a mobile terminal, a TV, or a computer. The mobile terminal includes any type of terminals that may provide an album function based on pictures or videos captured with a camera, for example, a mobile communication device, a digital camera, or a portable multimedia player (PMP). Also, the mobile communication device includes a cellular phone, a personal communication system (PCS), a personal data assistant (PDA), and an International Mobile Telecommunication-2000 (IMT-2000) device.

Hereinafter, an apparatus for and method of detecting similar images will be described in detail.

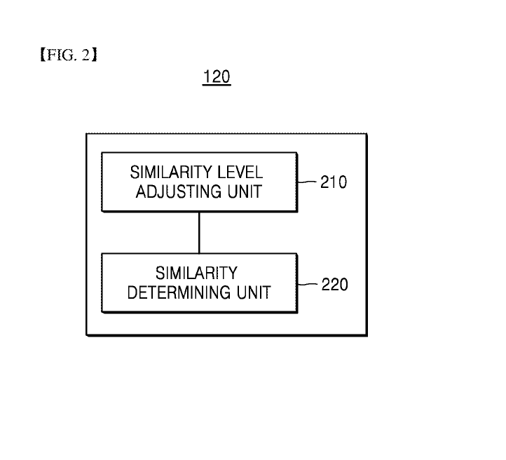

FIG. 2 is a block diagram of a similar image detection apparatus according to an exemplary embodiment.

According to an exemplary embodiment, the apparatus 120 may include a similarity level adjusting unit 210 and a similarity determining unit 220. However, the illustrated components are not all necessary. Thus, more or less number of components may be included in the apparatus 120. The illustrated components will be described below.

The similarity level adjusting unit 210 may adjust a similarity level used to determine a similarity between a plurality of images. The similarity level adjusting unit 210 may adjust the similarity level based on metadata of each of the images. The metadata may include at least one of time information and location information of each of the images.

The time information may include at least one of a captured date, a captured time, and an edited time with regard to each of the images. The edited time may be a time when an image is finally edited. Also, the location information may include GPS data with regard to each of the images.

According to an exemplary embodiment, the similarity level adjusting unit 210 may compare first metadata of a first image and second metadata of a second image. The first and second images are included in the plurality of images.

For example, the first metadata may include a captured date, a captured time, and a captured location with regard to the first image. The second metadata may also include a captured date, a captured time, and a captured location with regard to the second image. The similarity level adjusting unit 210 may select at least one of the captured time, the captured date, and the captured location in the metadata and compare the first metadata with the second metadata.

From among the plurality of images, the first image may be a reference image and the second image may be a comparison image for determining a similarity with the first image.

According to an exemplary embodiment, the similarity level adjusting unit 210 may adjust a similarity level used to determine a similarity between the first and second images based on the comparison result.

In particular, the similarity level may be adjusted based on a criterion that is predetermined by using a value of the first metadata and a value of the second metadata that correspond to the comparison. The predetermined criterion may include a matching ratio of respective hash values of the first and second images, the matching ratio being set according to a difference value.

According to an exemplary embodiment, the similarity determining unit 220 may determine the similarity based on the adjusted similarity level and the respective hashes of the plurality of images. The similarity indicates similarity information between the plurality of images. Also, the hashes may be generated based on fingerprint information of the plurality of images.

According to an exemplary embodiment, the similarity determining unit 220 may match the respective hash values of the plurality of images with one another, and determine the similarity between the plurality of images based on the matching result and the similarity level.

For example, form among the plurality of images, a first image may be set as a reference image and a second image, other than the first image, may be set as a comparison image. A similarity determining unit may estimate a matching value by comparing a hash value of the first image with a hash value of the second image.

The matching value may be a ratio value that indicates a matching degree between the hash value of the first image and the hash value of the second image. Therefore, the matching value may be large or small depending on whether the matching degree is high or low.

According to an exemplary embodiment, the similarity determining unit 220 may determine the similarity between the plurality of images by comparing the matching value and the similarity level.

For example, when a captured date and time of the first image is Sep. 3, 2014, 09:00 and a captured date and time of the second image is Sep. 3, 2014, 09:01, the apparatus 120 may not determine, but predict that the first and second images are similar images. In order to determine whether the first and second images are similar images, the apparatus 120 may match a hash value of the first image and a hash value of the second image based on a similarity level. When the respective captured dates of the first and second images are the same, the similarity level may be adjusted according to a difference between the respective captured times of the first and second images. When the difference between the respective captured times is one minute and a matching ratio of the respective hash values of the first and second images is 30%, the similarity level may be adjusted such that the apparatus 120 may determine the first and second images as similar images.

As another example, when the captured date and time of the first image is Sep. 3, 2013, 09:00 and the captured date and time of the second image is Sep. 3, 2014, 09:01, the first and second images may be similar images that are show the same person that is captured at the same location. It can be noted that a difference between the respective captured dates of the first and second images is one year, that is, a great amount of time has passed. When the matching ratio of the respective hash values of the first and second images is 99%, the similarity level may be adjusted such that the apparatus 120 may determine the first and second images as similar images.

According to an exemplary embodiment, the apparatus 120 may include a central computation processor to control overall operations of the similarity level adjusting unit 210 and the similarity determining unit 220. The central computation processor may be provided as an array of a plurality of logic gates or as a combination of a universal microprocessor and memory that stores a program that may be executed in the universal microprocessor. One of ordinary skill in the art to which the exemplary embodiments pertain may understand that the central computation processor may be formed by using various types of hardware.

According to an exemplary embodiment, a similar image detection apparatus may adjust a similarity level by using metadata of a plurality of images, obtain a matching value by matching a hash value of a reference image with a hash value of a comparison image, and compare the matching value with the similarity level. Thus, accuracy and performance of similar image detection may be secured.

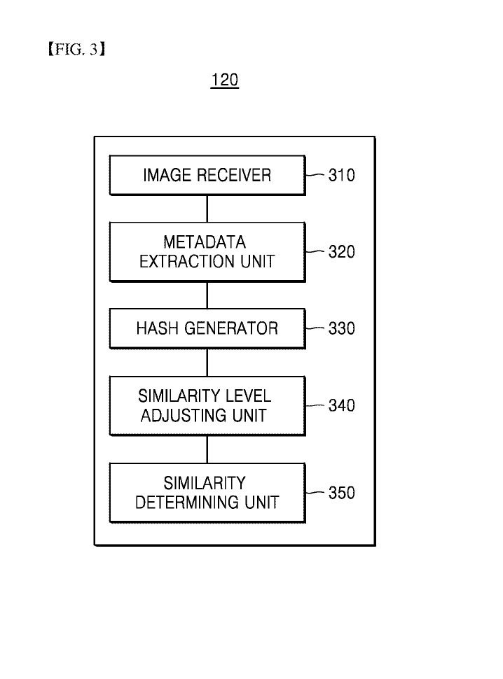

FIG. 3 is a block diagram of a similar image detection apparatus according to another exemplary embodiment.

According to another exemplary embodiment, the apparatus 120 may include an image receiver 310, a metadata extraction unit 320, a hash generator 330, a similarity level adjusting unit 340, and a similarity determining unit 350. However, the illustrated components are all necessary. Thus, more or less number of components may be included in the apparatus 120. The illustrated components will be described below.

According to an exemplary embodiment, the image receiver 310 may receive a plurality of images. The image receiver 310 may directly receive a plurality of images captured by a camera embedded in the apparatus 120. Also, the image receiver 310 may receive a plurality of image from an external apparatus other than the apparatus 120.

According to an exemplary embodiment, the metadata extraction unit 320 may extract metadata of each of the images. The metadata of each of the images may include at least one of time information and location information with regard to each of the images. The time information may include at least one of a captured date, a captured time, and an edited time with regard to each of the images. The location information may include GPS data with regard to each of the images.

For example, a first image and a second image may be included in the plurality of images. First metadata of the first image may include at least one of time information and location information with regard to the first image. Second metadata of the second image may include at least one of time information and location information with regard to the second image.

According to an exemplary embodiment, the metadata extraction unit 320 may extract the metadata by analyzing header information of the plurality of images. For example, when Exif data is recorded in a header in a file such as JPEG data or TIFF data, the metadata extraction unit 320 may extract at least one of time information and location information from the Exif data.

According to an exemplary embodiment, the hash generator 330 may transform fingerprint information, which corresponds to a feature of an image, into a hash format. The hash generator 330 may transform fingerprint information of each of the images into a hash format. The fingerprint information may include at least one of color difference signal distribution information, feature information, and edge detection information of each of the images.

According to an exemplary embodiment, when R-G-B color difference signal distribution information of an image is used as a feature, the hash generator 330 may use a histogram of each of R-G-B channels in a hash format. In this case, the histogram of each of the R-G-B channels may be directly stored as a hash, or stored after transforming a histogram distribution into a binary bit string.

According to an exemplary embodiment, the hash generator 330 may detect features by using Speeded Up Robust Features (SURF) or Scale Invariant Feature Transform (SIFT). The hash generator 330 may use a detected feature in a hash format. In the case of SURF/SIFT, each feature is in the form of a 128-order vector, and this may be referred to as P[128]. When using N features, N×P[128] may be a single piece of hash information.

According to an exemplary embodiment, the hash generator 330 may transform the feature into a binary string. With regard to the 128-order vector, a hash may be transformed into a 128-bit binary string by setting a component with a value greater than a median of values of components to 1 and a component with a value smaller than the median to 0. In this case, one feature is 128-bit, and when N features are used, an N×128 bit hash may be generated.

According to an exemplary embodiment, the hash generator 330 may detect an edge of an image by using at least one of the discrete cosine transform (DCT), the Fourier-Mellin transform (FMT), and the Radon transform, and thus detect features. The hash generator 330 may use the detected features as hashes.

The similarity level adjusting unit 340 and the similarity determining unit 350 are already described with reference to FIG. 2. The similarity level adjusting unit 340 and the similarity determining unit 350 of FIG. 3 are the same as the similarity level adjusting unit 210 and the similarity determining unit 220 of FIG. 2 and perform the same functions.

According to an exemplary embodiment, the similarity level adjusting unit 340 may adjust a similarity level by comparing the first metadata of the first image and the second metadata of the second image. For example, when the metadata includes time information, the similarity level adjusting unit 340 may obtain a difference between two image captured times, and adjust the similarity level such that a detection rate increases as the difference decreases. Also, the similarity level adjusting unit 340 may adjust the similarity level such that accuracy is greater than the detection rate when there is a large difference between respective captured times or respective generation times of two images.

According to an exemplary embodiment, the similarity determining unit 350 may determine the similarity by matching respective hash values of the first and second images. In this case, the first image may be a reference image and the second image may be a comparison image for determining similarity with the first image.

According to an exemplary embodiment, the matching may include determining a Hamming distance value of each of binary string hashes as the similarity. The similarity determining unit 350 may determine whether the first image is similar to second image by using the matching value and the similarity level.

According to an exemplary embodiment, the apparatus 120 may receive a plurality of images, and adjust the similarity level by using metadata of each of the received plurality of images. Respective hash values of the plurality of images may be matched to each other, and the matching result may be compared with the similarity level, and thus, similar images may be detected.

According to an exemplary embodiment, the apparatus 120 may group the plurality of images based on the similarity. The apparatus 120 may store the grouped similar images. The apparatus 120 may store the grouped similar images in an inner storage unit or in a storage unit of an external apparatus. The storage unit is an ordinary storage medium, and one of ordinary skill in the art would be able to understand that the storage unit may include a hard disk drive (HDD), a read-only memory (ROM), a random access memory (RAM), a flash memory, or a memory card.

Also, the apparatus 120 may further include a display unit and display the grouped images on the display unit.

The display unit according to an exemplary embodiment may be mounted on the apparatus 120, or a remote control apparatus that is externally provided. According to an exemplary embodiment, the remote control apparatus may be provided in various ways. For example, the remote control apparatus may include a display-specific remote control, or a mobile terminal such as a smartphone, a mobile phone, a tablet PC, etc.

According to an exemplary embodiment, the apparatus 120 may group similar images from among the plurality of images based on the determined similarity. By grouping the similar images, the user may be able to more conveniently gather similar images and create albums. Also, this function may be utilized in an image search service, for example, searching pictures stored in a mass storage server for pictures that are similar to an input picture.

According to an exemplary embodiment, from among first and second similar images, the apparatus 120 may delete the second similar image based on the determined similarity. By deleting an unnecessary image from identical or similar images, the user may be able to more conveniently gather similar images and create albums.

According to an exemplary embodiment, the apparatus 120 may include a central computing processor and control overall operations of the image receiver 310, the metadata extraction unit 320, the hash generator 330, the similarity level adjusting unit 340, and the similarity determining unit 350. The central computation processor may be provided as an array of a plurality of logic gates or as a combination of a universal microprocessor and a memory that stores a program that may be executed in the universal microprocessor. One of ordinary skill in the art to which the exemplary embodiments pertain may understand that the central computation processor may be formed by using various types of hardware.

Hereinafter, various operations or functions performed by a similar image detection apparatus will be described. Even when an image receiver, a metadata extraction unit, a hash generator, a similarity level adjusting unit, and a similarity determining unit are not specifically described, features that would have been understood or expected by one of ordinary skill in the art may be regarded as their general features. The scope of the present invention is not limited to a name or physical/logical structure of a specific component.

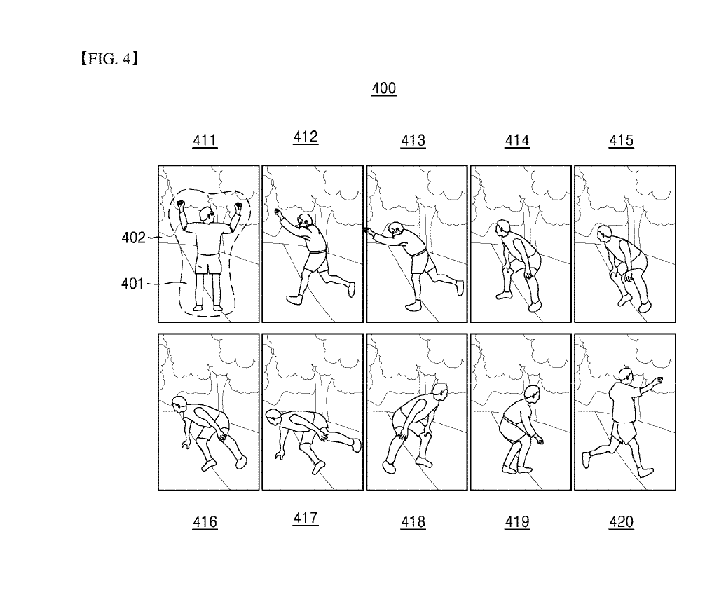

FIG. 4 is an exemplary diagram of a result of similar image detection, according to an exemplary embodiment.

As shown in 400 of FIG. 4, a similar image detection apparatus may set similar pictures 411 to 420 from among a plurality of images as a group. When the user selects the group, the similar pictures 510 and 520 may be displayed on a display unit.

Pictures 411 to 420 are pictures of a child performing sequential motions including standing, touching a ground, sitting, and standing up. The pictures 411 to 420 may be all captured at Sep. 3, 2014, with a time interval of 0.1 second between each picture. Hereinafter, a process of detecting similar images described with reference to FIG. 4 will be described based on the conditions above.

According to an exemplary embodiment, the similar image detection apparatus may receive the pictures 411 to 420, showing the child performing sequential motions including standing, touching the ground, sitting, and standing up, and pictures that are not related to the motions of the child. The similar image detection apparatus may receive a plurality of pictures by capturing with an embedded camera or from an external apparatus.

The similar image detection apparatus may extract metadata from the plurality of pictures. Metadata of each of the pictures 411 to 420 related to the motions of the child may include a captured date, a captured time, and a captured location. The captured dates may all be Sep. 3, 2014, and the captured times may be different with an interval of 0.1 second each.

The similar image detection apparatus may transform fingerprint information, which corresponds to features of the plurality of pictures, into a hash format. The similar image detection apparatus may extract fingerprint information of the pictures 411 to 420 that are related to the motions of the child and fingerprint information of the pictures not related to the motions of the child. For example, the similar image detection apparatus may extract the features and show in the form of a vector, and transform the vector format into a hash format.

The similar image detection apparatus may adjust a similarity level based on the metadata of the plurality of pictures. The similar image detection apparatus may match respective hash values of the plurality of pictures to one another, compare the matching result with the similarity level, and thus determine similarity. In the pictures 411 to 420 that are related to the motions of the child, portions (for example, a portion 401) occupied by the child are not matched to one another, but portions (for example, a portion 402) without the child are matched to one another.

For example, when the pictures 411 to 420 related to the motions of the child and the pictures not related to the motions of the child have the same captured dates, the same captured times and the same captured locations, the similar image detection apparatus may not be able to accurately detect the pictures 411 to 420 by only comparing the metadata.

Therefore, the similar image detection apparatus may determine the similarity by comparing the matching result of the respective hash values of the plurality of pictures with the similarity level. The similar image detection apparatus may increase the similarity level to accurately detect similar pictures. From among the plurality of pictures, when a hash value of a first picture and a hash value of a second picture are lower than the increased similarity level, the similar image detection apparatus may determine that the first picture and the second picture are not similar images. From among the plurality of pictures, when the hash value of the first picture and the hash value of the second picture are higher than the increased similarity level, the similar image detection apparatus may determine that the first picture and the second picture are similar images.

As another example, when there is a great difference between the respective captured dates, the respective captured times, and the respective captured locations of the pictures 411 to 420 and the pictures not related to the motions of the child, the similar image detection apparatus may detect approximately similar pictures by only comparing the metadata. In order to increase accuracy of detecting similar picture, the similarity may be determined by comparing the matching result of the respective hash values of the plurality of pictures with the similarity level.

In this case, the similar image detection apparatus may decrease the similarity level to detect similar pictures. From among the plurality of pictures, when the hash value of the first picture and the hash value of the second picture are lower than the decreased similarity level, the similar image detection apparatus may determine that the first picture and the second picture are not similar images. From among the plurality of pictures, when the hash value of the first picture and the hash value of the second picture are higher than the decreased similarity level, the similar image detection apparatus may determine that the first picture and the second picture are similar images.

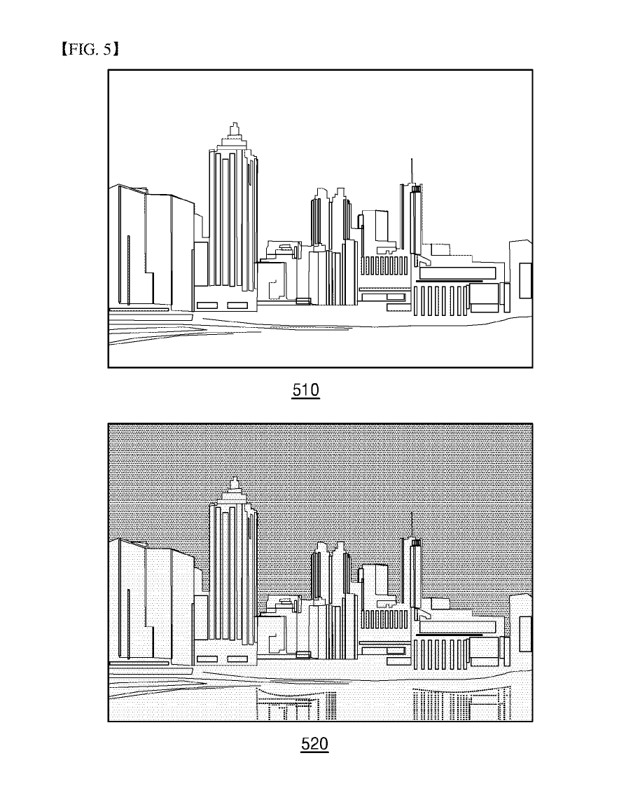

FIG. 5 is an exemplary diagram of a result of similar image detection, according to another exemplary embodiment.

As shown in FIG. 5, the similar image detection apparatus may set similar pictures 510 and 520 from among plurality of images as a group. When the user selects the group, the similar pictures 510 and 520 may be displayed on the display unit.

The pictures 510 and 520 have the same captured locations but different captured times. In some cases, the user may have to classify the pictures 510 and 520 as similar pictures. The user may use the similar image detection apparatus to detect the pictures 510 and 520 as similar pictures.

Metadata of the picture 510 and metadata of the picture 520 have the same captured locations but different captured times. In this case, the similar image detection apparatus may adjust a similarity level and thus detect the pictures 510 and 520 as similar pictures.

In this case, even when the metadata of each of the pictures 510 and 520 are different, the similar image detection apparatus may increase the similarity level and detect the pictures 510 and 520 as similar picture.

The pictures 510 and 520 may be determined as similar pictures when a matching value of respective hash values of the pictures 510 and 520 is greater than the similarity level. Therefore, even when the pictures 510 and 520 are captured at different time, the similar image detection apparatus may increase the similarity level and thus detect the pictures 510 and 520 as similar pictures.

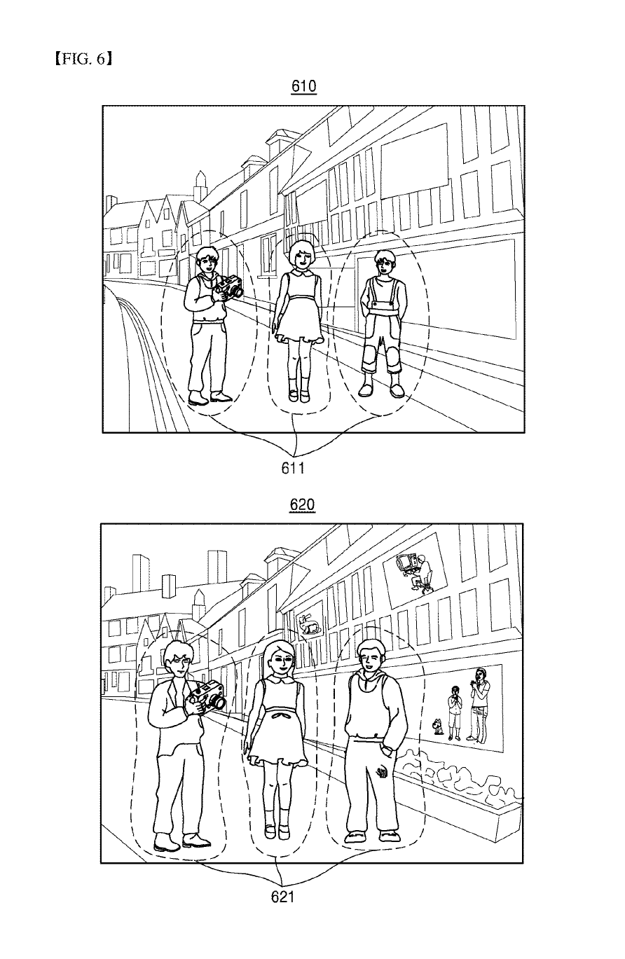

FIG. 6 is an exemplary diagram of a result of similar image detection, according to another exemplary embodiment.

As shown in FIG. 6, the similar image detection apparatus may set similar pictures 610 and 620 from among plurality of images as a group. When the user selects the group, the similar pictures 610 and 620 may be displayed on the display unit.

The pictures 610 and 620 have the same captured locations but different captured dates. In some cases, the user may have to classify pictures showing an identical person captured at an identical location over time as similar pictures. The user may use the similar image detection apparatus to detect the pictures 610 and 620 as similar pictures.

Metadata of the picture 610 and metadata of the picture 620 have the same captured locations but different captured dates. In this case, the similar image detection apparatus may adjust a similarity level and thus detect the pictures 610 and 620 as similar pictures. Even when the captured locations of the pictures 610 and 620 are the same, if a certain amount of time has passed, an area that changes over time in a comparison picture may be different from a corresponding area in a reference picture. Therefore, the similar image detection apparatus may adjust a similarity level with respect to an area that changes over time and an area that does not change over time and thus detect the pictures 610 and 620 as similar images.

Although an example in which pictures are used in the similar image detection method is described with reference to FIGS. 4 to 6, the similar image detection method is not limited thereto, and may be applied to videos and other types of images.

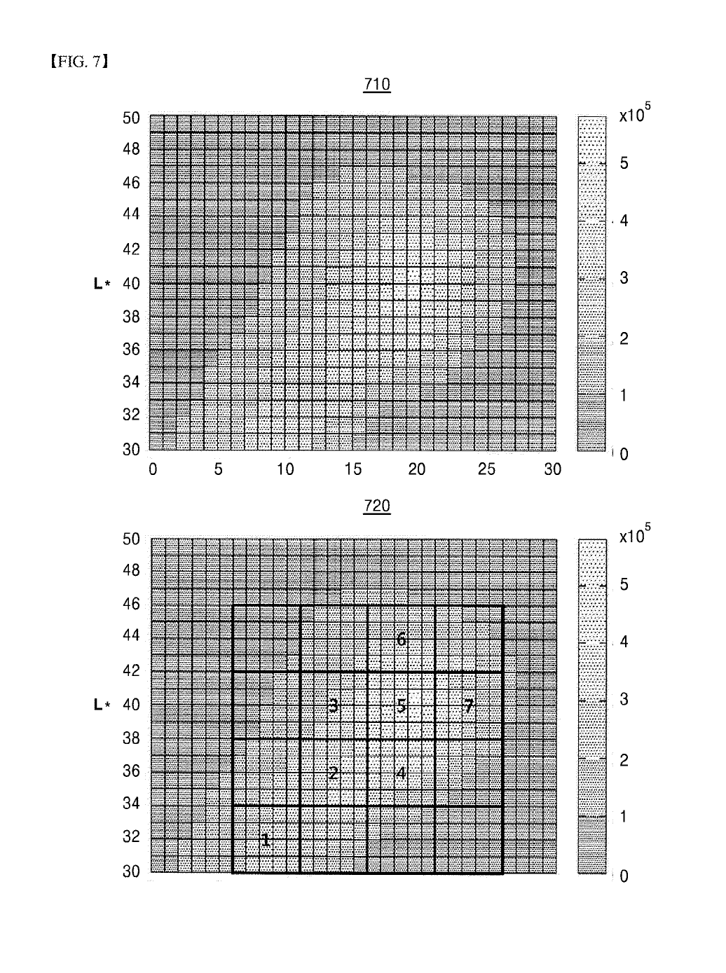

FIG. 7 is diagrams for describing obtaining of fingerprint information of images by using histograms, according to an exemplary embodiment.

A color histogram 710 of FIG. 7 is obtained by analyzing an image with regard to chroma and. A horizontal axis represents chroma, and a vertical axis represents brightness. Also, distribution of unit areas by using colors.

According to an exemplary embodiment, the similar image detection apparatus may use a color histogram of an image as fingerprint information that corresponds to a feature of the image.

According to an exemplary embodiment, the similar image detection apparatus may store the color histogram in a hash format, or transform a color histogram distribution into a binary bit string format and store the transformed color histogram distribution.

In 720 of FIG. 7, the histogram 710 is quantized by dividing areas into grids.

According to an exemplary embodiment, the similar image detection apparatus may combine a plurality of unit areas into a single range, and compare the range with a corresponding portion in a histogram of a comparison image. The range may include a plurality of unit areas, and chroma and brightness values of the unit areas may be identical or different.

According to an exemplary embodiment of the present invention, 5 units of chroma and 4 units of brightness may be set to a range. Although unit areas in a range may have different chroma and brightness values, the range may be indicated by using a single value.

As shown in 720 of FIG. 7, the similar image detection apparatus may divide the color histogram into a 4×4 grid. Although the unit areas may have different chroma and brightness values, a single range may be set to have a single value and then be compared with a color histogram of a comparison target. The comparison is performed by matching corresponding portions in respective color histograms of two images. In this case, the similar image detection apparatus may change a histogram distribution value into a hash format, and determine whether the respective hash values match one another.

According to an exemplary embodiment, as shown in 720 of FIG. 7, whether respective histograms of a plurality of images match each other may be determined based on a first range to a seventh range, and thus, similarity of the plurality of images may be determined.

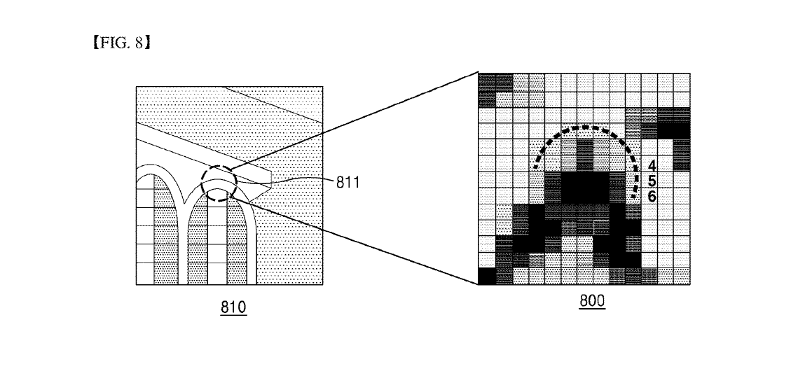

FIG. 8 is diagrams for describing obtaining fingerprint information of an image by feature extraction, according to another exemplary embodiment.

According to an exemplary embodiment, the similar image detection apparatus may extract features to obtain fingerprint information that corresponds to a feature of an image.

As shown in 810 of FIG. 8, the similar image detection apparatus may determine whether a point 811 is a corner by using a feature. For example, as shown in 820 of FIG. 8, whether the point 811 is a corner may be determined based on 16 pixel values on a circle about the point 811. When there are n sequential pixels that are brighter or darker than the point 811 by a certain value, the point 811 may be determined as a corner. The similar image detection apparatus may transform a hash into a binary string by setting a portion determined as a corner as 1 and a portion not determined as a corner as 0. The similar image detection apparatus may determine the similarity between the plurality of images based on the hash and the similarity level.

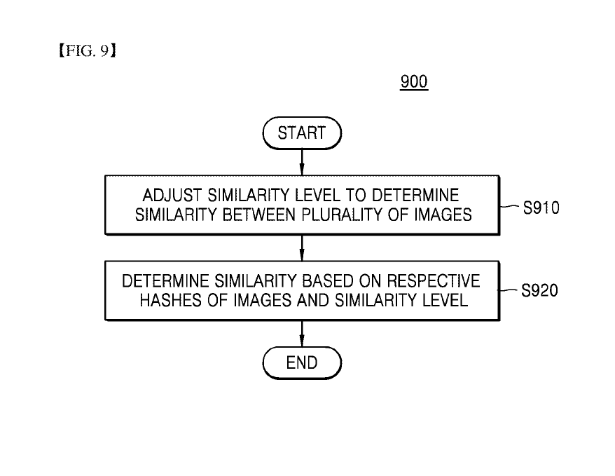

FIG. 9 is a flowchart of a method of detecting similar images, according to an exemplary embodiment.

As shown in FIG. 9, in operation 910, the similar image detection apparatus may adjust a similarity level based on metadata of each of a plurality of images. The similarity level may be used to determine the similarity between the plurality of images. The metadata of each of the images may include at least one of time information and location information of each of the images.

According to an exemplary embodiment, the similar image detection apparatus may compare first metadata of a first image and second metadata of a second image. The first and second images are included in the plurality of images. The first image may be a reference image, and a second image may be a comparison image that is compared with the reference image.

According to an exemplary embodiment, the similar image detection apparatus may adjust the similarity level based on a criterion that is predetermined by using a difference value of a value of the first metadata and a value of the second metadata. The predetermined criterion may include a matching ratio of respective hash values of the first and second images, which is set according to the difference value.

In operation 920, the similar image detection apparatus may determine the similarity between the plurality of images based on respective hashes of the plurality of images and the similarity level. The hashes may be generated by using fingerprint information of each of the images.

According to an exemplary embodiment, the similar image detection apparatus may match the respective hash values of the plurality of images with one another, and determine the similarity between the plurality of images based on the matching result and the similarity level. The matching result may include a matching value indicating the matching ratio. The similar image detection apparatus may determine the similarity between the plurality of images by comparing the matching value and the similarity level.

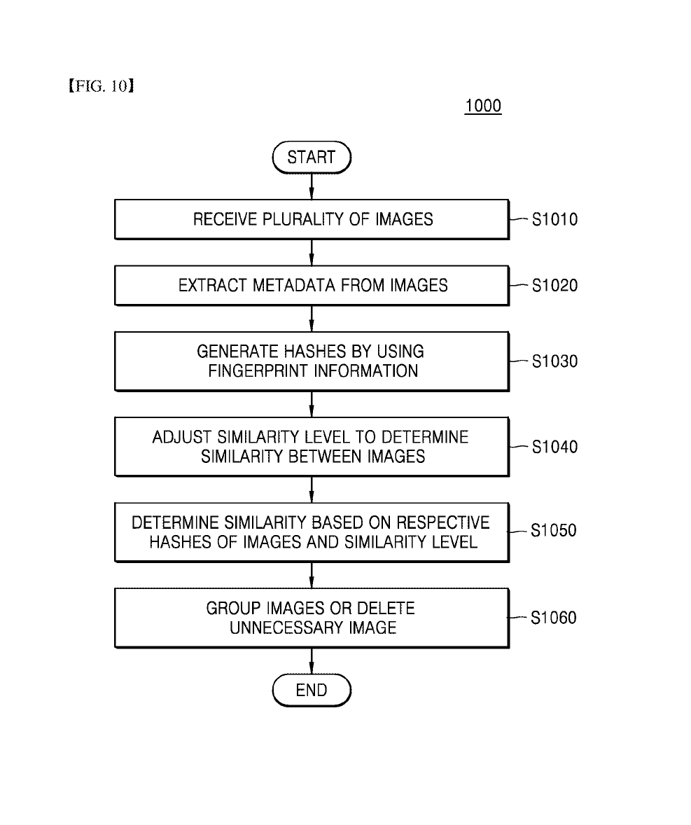

FIG. 10 is a flowchart of a method of detecting similar images, according to another exemplary embodiment.

As shown in FIG. 10, in operation 1010, the similar image detection apparatus may receive a plurality of images. The similar image detection apparatus may receive a plurality of images captured by a camera embedded in the similar image detection apparatus or from an external apparatus.

In operation 1020, the similar image detection apparatus may extract metadata of each of the images from the plurality of images. The metadata of each of the images may include at least one of time information and location information of each of the images. The time information may include at least one of a captured date, a captured time, and an edited time with regard to each of the images. The location information may include GPS data related to each of the images.

In operation 1030, the similar image detection apparatus may generate hashes by using fingerprint information of each of the images. The fingerprint information may include at least one of color difference signal distribution information, feature information, and edge detection information of each of the images.

According to an exemplary embodiment, the color difference signal distribution information may include at least one of respective histograms of the plurality of images and bit strings of the histograms. Also, the feature information may be detected by using SURF or SIFT, and the edge detection information may be detected by using at least one of the DCT, the FMT, and the Radon Transform.

Operations 1040 and 1050 correspond to operations 910 and 920 of FIG. 9.

In operation 1060, the similar image detection apparatus may group the plurality of image into similar image based on the determined similarity. Also, when first and second images are determined as similar images from among the plurality of images, the similar image detection apparatus may delete an unnecessary image from among the first and second images.

The above-described apparatuses may be provided as a hardware component, a software component, and/or a combination thereof. For example, the apparatuses and the components described in exemplary embodiments may be at least one general-purpose computer or a specific-purpose computer, for example, a processor, a controller, an arithmetic logic unit (ALU), a digital signal processor (DSP), a micro computer, a field programmable array (FPA), a programmable logic unit (PLU)), a microprocessor, or any apparatus capable of executing and responding to instructions.

A processing apparatus may run an operating system (OS) and at least one software application that is executed on the OS. Also, the processing apparatus may access, control, process, and generate data in response to execution of software.

For convenience of description, it may be described that only one processing apparatus is used. However, one of ordinary skill in the art would be able to understand that the processing apparatus may include a plurality of processing elements and/or multiple types of processing elements. For example, the processing apparatus may include a plurality of processors, or a processor and a controller. Other processing configurations may be adapted, for example, parallel processors.

Software may include at least one of computer programs, codes, instructions, and a combination thereof, for independently or collectively instructing or configuring the processing apparatus to operate in a desired manner.

Software and data may be embodied permanently or temporarily in any type of machine, component, physical or virtual equipment, computer storage medium or device, or in a propagated signal wave capable of providing instructions or data to or being interpreted by the processing apparatus. The software also may be distributed over network coupled computer systems so that the software is stored and executed in a distributed fashion. In particular, the software and data may be stored by at least one computer-readable recording medium.

The method according to the above-described exemplary embodiments may be recorded in non-transitory computer-readable media including program instructions to implement various operations embodied by a computer. The non-transitory computer-readable media may also include, independently or as a combination, program instructions, data files, data structures, and the like. The non-transitory computer-readable recording media may include program instructions, data files, data structures, or a combination thereof. The program instructions may be specifically designed for the present inventive concept or well-known to one of ordinary skill in the art of computer software.

Examples of the non-transitory computer-readable recording media include magnetic media (e.g., hard disks, floppy disks, or magnetic tapes), optical media (e.g., CD-ROMs or DVDs), magneto-optical media (e.g., floptical disks), and hardware devices specifically designed to store and execute the program instructions (e.g., ROM or RAM).

Examples of the program instructions not only include machine codes that are made by compilers but also computer-executable high level language codes that may be executed by using an interpreter.

The above-described hardware devices may be configured to function as one or more software modules in order to perform the operations of the above-described exemplary embodiments, or vice versa.

Although the present inventive concept has been described with reference to a limited number of exemplary embodiments and drawings, one of ordinary skill in the art would be capable of amending and modifying based on the description above. Appropriate results may be obtained even when, for example, the above-described methods are performed in a different order from the description above, and/or the above-described components, such as systems, structures, devices, and circuits, are combined in a manner different from the description above or replaced with substitutions or equivalents.

Therefore, the scope of the present invention is not limited to the above-described exemplary embodiments, but by the appended claims, and all differences within the scope will be construed as being included in the present invention.

1. A method of detecting similar images, the method comprising:
adjusting, based on metadata of each of a plurality of images, a similarity level used to determine a similarity between the plurality of images, wherein the metadata of each of the images comprises at least one of time information and location information of each of the images; and
determining the similarity based on the adjusted similarity level and a hash generated based on fingerprint information of each of the images.

2. The method of claim 1, wherein the adjusting of the similarity level comprises:
comparing first metadata of a first image with second metadata of a second image from among the plurality of images; and
adjusting, based on a result of the comparing, a similarity level used to determine a similarity between the first image and the second image.

3. The method of claim 2, wherein the adjusting of the similarity level used to determine the similarity between the first image and the second image comprises adjusting the similarity level according to a criterion that is predetermined based on a difference value of a value of the first metadata and a value of the second metadata.

4. The method of claim 3, wherein the criterion comprises a matching ratio of respective hash values of the first and second images, the matching ratio being set according to the difference value.

5. The method of claim 1, wherein the determining of the similarity comprises:
matching respective hash values of the images to each other; and
determining the similarity between the images based on a result of the matching and the adjusted similarity level.

6. The method of claim 1, further comprising extracting the metadata of each of the images.

7. The method of claim 6, wherein the time information comprises at least one of a captured date, a captured time, and an edited time of each of the images, and
the location information comprises GPS data of each of the images.

8. The method of claim 1, further comprising generating a hash based on fingerprint information of each of the images,
wherein the fingerprint information comprises at least one of color difference signal distribution information, feature information, and edge detection information of each of the images.

9. The method of claim 8, wherein the color difference signal distribution information comprises at least one of a histogram of each of the images and a bit string of the histogram.

10. The method of claim 8, wherein the feature information is detected based on Speeded Up Robust Features (SURF) or Scale Invariant Feature Transform (SIFT), and
the edge detection information is detected based on at least one of the discrete cosine transform (DCT), the Fourier-Mellin transform (FMT), and the Radon transform.

11. The method of claim 1, further comprising grouping similar images from among the plurality of images based on the determined similarity.

12. The method of claim 1, further comprising deleting from among a first image and a second image having an identical similarity the second image based on the determined similarity.

13. An apparatus for detecting similar images, the apparatus comprising:
a similarity level adjusting unit configured to adjust, based on metadata of each of a plurality of images, a similarity level used to determine a similarity between the plurality of images, wherein the metadata of each of the images comprises at least one of time information and location information of each of the images; and
a similarity determining unit configured to determine the similarity based on the adjusted similarity level and a hash generated based on fingerprint information of each of the images.

14. The apparatus of claim 13, wherein the similarity level adjusting unit is configured to compare first metadata of a first image and second metadata of a second image from among the plurality of images, and adjust, based on a result of the comparing, a similarity level used to determine a similarity between the first and second images.

15. A non-transitory computer-readable recording medium having recorded thereon a program, which, when executed by a computer, performs a similar image detection method comprising:
adjusting, based on metadata of each of a plurality of images, a similarity level used to determine a similarity between the plurality of images, wherein the metadata of each of the images comprises at least one of time information and location information of each of the images; and
determining the similarity based on the adjusted similarity level and a hash generated based on fingerprint information of each of the images.
